(19) United States
(12) Patent Application Publication
(10) Pub. No.: US 2017/0111858 A1
(43) Pub. Date: Apr. 20, 2017

(54) WAKE UP PACKET DESIGN FOR LOW-POWER WAKE-UP RECEIVER IN A WIRELESS NETWORK

(71) Applicants: Shahrnaz Azizi, Cupertino, CA (US); Minyoung Park, Portland, OR (US); Thomas J. Kenney, Portland, OR (US)

(72) Inventors: Shahrnaz Azizi, Cupertino, CA (US); Minyoung Park, Portland, OR (US); Thomas J. Kenney, Portland, OR (US)

(21) Appl. No.: 14/973,378

(22) Filed: Dec. 17, 2015

Related U.S. Application Data
(60) Provisional application No. 62/243,244, filed on Oct. 19, 2015.

(51) Int. Cl. H04W 52/02; H04L 27/26; H04L 5/00; H04L 29/08

(52) U.S. Cl. CPC H04W 52/0212; H04L 67/145; H04L 27/2628; H04L 5/0007; H04W 84/02

(57) ABSTRACT

An apparatus is disclosed. The apparatus comprising processing circuitry configured to encode a wake-up packet to be transmitted on one or more sub-channels to one or more low-power wake-up receivers (LP-WURs), where each of the wake-up packets are to be 26 data tones or 52 data tones, where the wake-up packet comprises one or more wake-up pulses; and cause to be transmitted the one or more wake-up packets on the one or more sub-channels An apparatus of a LP-WUR is disclosed. The apparatus comprising processing circuitry configured to: decode a wake-up packet on a sub-channel, wherein the wake-up packet comprises one or more wake-up pulses, where each of the one or more wake-up pulses is to be 26 data tones or 52 data tones, and if the wake-up packet encodes an identifier of the LP-WUR, then the LP-WUR is to generate an exit a power save mode signal.

### PRIORITY CLAIM

This application claims the benefit of priority under 35 USC 119(e) to U.S. Provisional Patent Application Ser. No. 62/243,244, filed Oct. 19, 2015, which is incorporated herein by reference in their entirety.

### TECHNICAL FIELD

Embodiments relate to Institute of Electrical and Electronic Engineers (IEEE) 802.11. Some embodiments relate to a construction of a wake-up packet or pulse for waking up a wireless local-area network (WLAN) device with low-power wake-up receiver (LP-WUR) within an IEEE 802.11ax network. Some embodiments relate to a frequency domain sequence and generation of a wake-up packet for 26-tones and 52-tones for an IEEE 802.11ax orthogonal frequency division multiple-access (OFDMA) resource units (RU).

### BACKGROUND

Low power wireless devices are enabling many wireless devices to be deployed in wireless local-area network (WLAN). However, the low power wireless devices are bandwidth constrained and power constrained, and yet need to communicate with central devices to download and upload data. Additionally, wireless devices may need to operate with both newer protocols and with legacy device protocols.

### BRIEF DESCRIPTION OF THE DRAWINGS

The present disclosure is illustrated by way of example and not limitation in the figures of the accompanying drawings, in which like references indicate similar elements and in which:

FIG. 1 illustrates a wireless network in accordance with some embodiments;

FIG. 2 illustrates time domain samples of a wake-up packet in accordance with some embodiments;

FIG. 3 illustrates a simulation to compare the performance of the disclosed 2 MHz pulses with legacy 4 MHz pulses;

FIG. 4 illustrates a simulation to compare the performance of the disclosed 2 MHz pulses with legacy 4 MHz pulses with additive white Gaussian noise (AWGN);

FIG. 5 illustrates a LP-WUR packet in accordance with some embodiments;

FIG. 6 illustrates a method of waking up a wireless device in accordance with some embodiments;

FIG. 7 illustrates a HEW device in accordance with some embodiments; and

FIG. 8 illustrates a LP-WUR in accordance with some embodiments.

### DESCRIPTION

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

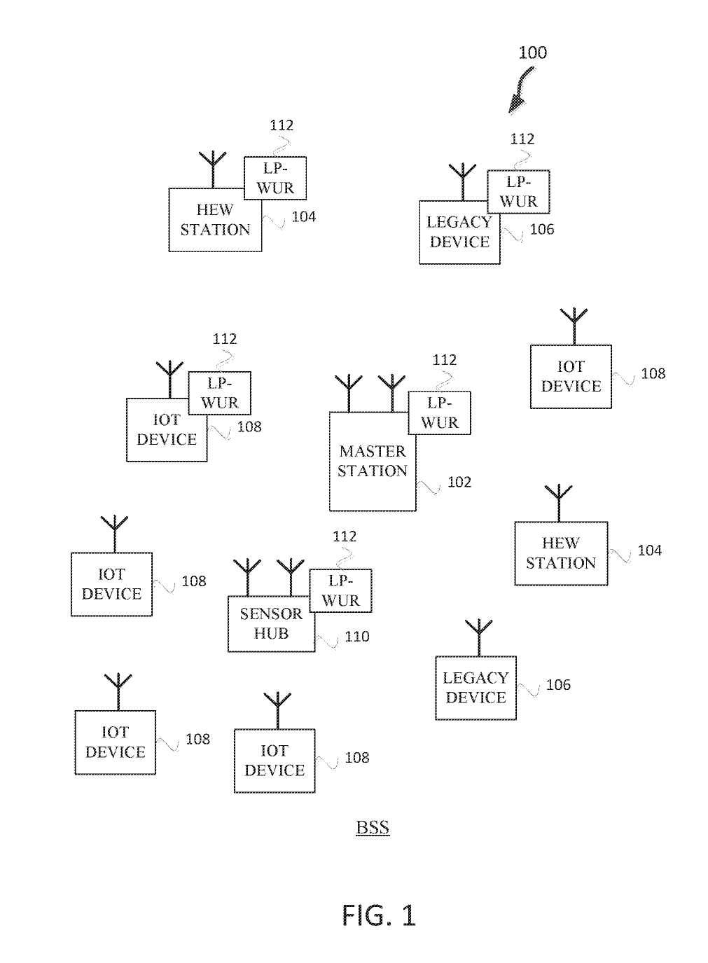

FIG. 1 illustrates a WLAN 100 in accordance with some embodiments. The WLAN may comprise a basis service set (BSS) 100 that may include a master stations 102, which may be an AP, a plurality of high-efficiency wireless (HEW) (e.g., IEEE 802.11ax) STAs 104, a plurality of legacy (e.g., IEEE 802.11n/ac) devices 106, a plurality of IoT devices 108 (e.g., IEEE 802.11ax), and a sensor hub 110.

The master station 102 may be an AP using the IEEE 802.11 to transmit and receive. The master station 102 may be a base station. The master station 102 may use other communications protocols as well as the IEEE 802.11 protocol. The IEEE 802.11 protocol may be IEEE 802.11ax. The IEEE 802.11 protocol may include using orthogonal frequency division multiple-access (OFDMA), time division multiple access (TDMA), and/or code division multiple access (CDMA). The IEEE 802.11 protocol may include a multiple access technique. For example, the IEEE 802.11 protocol may include space-division multiple access (SDMA) and/or multiple-user multiple-input multiple-output (MU-MIMO).

The legacy devices 106 may operate in accordance with one or more of IEEE 802.11 a/b/g/n/ac/ad/af/ah/aj, or another legacy wireless communication standard. The legacy devices 106 may be STAs or IEEE STAs. The HEW STAs 104 may be wireless transmit and receive devices such as cellular telephone, smart telephone, handheld wireless device, wireless glasses, wireless watch, wireless personal device, tablet, or another device that may be transmitting and receiving using the IEEE 802.11 protocol such as IEEE 802.11ax or another wireless protocol. In some embodiments, the HEW STAs 104 may be termed high efficiency (HE) stations.

The master station 102 may communicate with legacy devices 106 in accordance with legacy IEEE 802.11 communication techniques. In example embodiments, the master station 102 may also be configured to communicate with HEW STAs 104 in accordance with legacy IEEE 802.11 communication techniques,

The IoT devices 108 may operate in accordance with 802.11ax or another standard of 802.11. The IoT devices 108 may operate on a smaller sub-channel than other the HEW stations 104. For example, the IoT devices 108 may operate on 2.03 MHz or 4.06 MHz sub-channels. In some embodiments, the IoT devices 108 are not able to transmit on a 20 MHz sub-channel to the master station 102 with sufficient power for the master station 102 to receive the transmission. In sonic embodiments, the IoT devices 108 are not able to receive on a 20 MHz sub-channel and must use a small sub-channel such as 2.03 MHz. The IoT devices 108, in some embodiments, may be long-range, low-power devices. The IoT devices 108 may be, in some embodiments, narrow band devices that are only able to transmit and receive a bandwidth less than 20 MHz.

The IoT devices 108 may be battery constrained. The IoT devices 108 may be sensors designed to measure one or more specific parameters of interest such as temperature sensor, humidity, etc. The IoT devices 108 may be location-specific sensors. Some IoT devices 108 may be connected to a sensor hub 110. The IoT devices 108 may upload data to the sensor hub 110. The sensor hubs 110 may upload the data to an access gateway (not illustrated) that connects several sensor hubs 110 and can connect to a cloud sever. The master station 102 may act as the access gateway in accordance with some embodiments. The master station 102 may act as the sensor hub 110 in accordance with some embodiments.

In some embodiments, the IoT devices 108 need to consume very low average power in order to perform a packet exchange with the sensor hub 110 and/or master station 102. The IoT devices 108 may be densely deployed.

In some embodiments, the master station 102, HEW station 104, legacy station 106, IoT devices 108, and/or sensor hub 110 may include a LP-WUR 112. In some embodiments, a Bluetooth™ device (not illustrated) may include a LP-WUR 112. The LP-WUR 112 may be a low-power receiver, e.g., 100 μW in listen state. The master station 102, HEW station 104, legacy station 106, IoT devices 108, and/or sensor hub 110 that have entered a power save mode may exit the power save when they receive a signal from the LP-WUR 112.

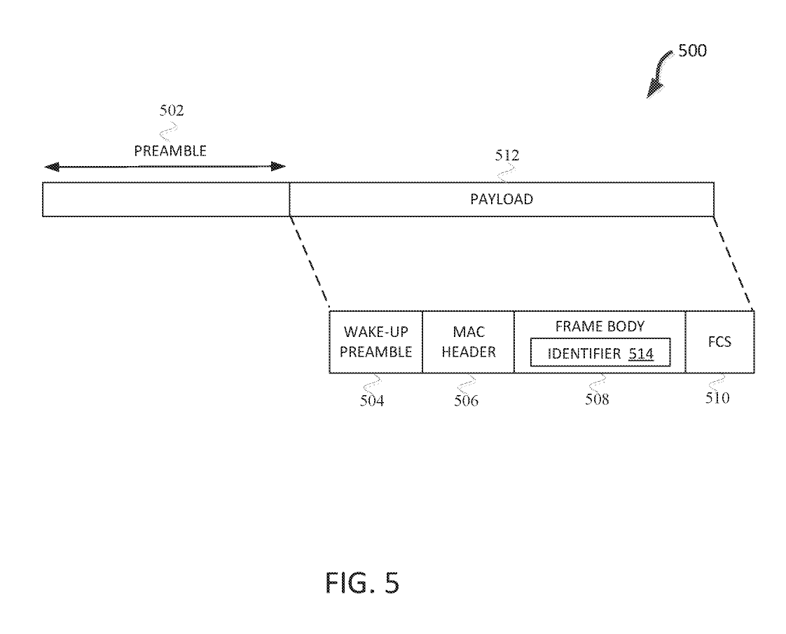

In some embodiments, the master station 102 HEW station 104, legacy station 106, IoT devices 108, Bluetooth™ devices, and/or sensor hubs 110 enter a power save mode and exit the power save mode periodically or at a pre-scheduled times to see if there is a packet for them to be received. In some embodiments, the master station 102, HEW station 104, legacy station 106, IoT devices 108, and/or sensor hub 110 enter a power save mode and remain in the power save mode until they receive a signal from LP-WUR 112. The power save mode may be a deep power save mode. The LP-WUR 112 may remain in a listen mode to receive a wake-up packet 500 (see FIG. 5). The wake-up packet 500 may encode an identifier 514 of the LP-WUR 112, and the LP-WUR 112 may only wake up the master station 102, HEW station 104, legacy station 106, IoT devices 108, Bluetooth™ devices, and/or sensor hubs 110 if the identifier 514 matches an identifier of the LP-WUR 112.

In some embodiments, a HEW frame may be configurable to have the same bandwidth as a subchannel. The bandwidth of a subchannel may be 20 MHz, 40 MHz, or 80 MHz, 160 MHz, 320 MHz contiguous bandwidths or an 80+80 MHz (160 MHz) non-contiguous bandwidth. In some embodiments, the bandwidth of a subchannel may be 2.03125 MHz, 4.0625 MHz, 8.28125 MHz, a combination thereof or another bandwidth that is less or equal to the available bandwidth may also be used. The subchannel may be based on a number of data tones, e.g. 26 or 52 with a number of subcarriers that may be used for other reasons such as DC nulls, guards intervals, or another use other than data tones. In some embodiments the bandwidth of the subchannels may be based on a number of active subcarriers.

In some embodiments, a LP-WUR 112 may be configurable to have the same bandwidth as a subchannel. The bandwidth of a subchannel may be 20 MHz. In some embodiments, the bandwidth of a subchannel may be less than 20 MHz. For example, it may be equivalent to one of OFDMA subchannels defined in IEEE 802.11ax. The OFDMA sub-channels of IEEE 802.11ax that are less than 20 MHz are equivalent to 26-tone, 52-tone and 106-tone allocations. The bandwidth of these OFDMA allocations may be 20 MHz divided by 256 of a Fast Fourier Transform (FFT)-size times 26 or 52 or 106, for bandwidths of 2.03125 MHz, 4.0625 MHz, or 8.28125 MHz, respectively. In some embodiments, the subchannels may be a combination thereof or another bandwidth that is less or equal to the available bandwidth may also be used. In some embodiments the bandwidth of the subchannels may be based on a number of active subcarriers. In some embodiments the bandwidth of the subchannels is 26, 52, or 106 active subcarriers or tones that are spaced by 1/256 of 20 MHz. In some embodiments the bandwidth of the subchannels is 256 tones spaced in 20 MHz. In some embodiments the subchannels are multiple of 26 tones or a multiple of 20 MHz. In some embodiments a 20 MHz subchannel may comprise 256 tones for a 256 point Fast Fourier Transform (FFT).

A HEW packet may be configured for transmitting a number of spatial streams, which may be in accordance with MU-MIMO. In other embodiments, the master station 102, HEW STA 104, and/or legacy device 106 may also implement different technologies such as code division multiple access (CDMA) 2000, CDMA 2000 1×, CDMA 2000 Evolution-Data Optimized (EV-DO), Interim Standard 2000 (IS-2000), Interim Standard 95 (IS-95), Interim Standard 856 (IS-856), Long Term Evolution (LTE), Global System for Mobile communications (GSM), Enhanced Data rates for GSM Evolution (EDGE), GSM EDGE (GERAN), IEEE 802.16 (i.e., Worldwide Interoperability for Microwave Access (WiMAX)), BlueTooth®, or other technologies.

Some embodiments relate to HEW communications. In accordance with some IEEE 802.11ax embodiments, a master station 102 may operate as a master station which may be arranged to contend for a wireless medium (e.g., during a contention period) to receive exclusive control of the medium for an HEW control period. In some embodiments, the HEW control period may be termed a transmission opportunity (TXOP). The master station 102 may transmit a HEW master-sync transmission, which may be a trigger packet or HEW control and schedule transmission, at the beginning of the HEW control period. The master station 102 may transmit a time duration of the TXOP and sub-channel information. During the HEW control period, HEW STAs 104 may communicate with the master station 102 in accordance with a non-contention based multiple access technique such as OFDMA or MU-MIMO.

This is unlike conventional WLAN communications in which devices communicate in accordance with a contention-based communication technique, rather than a multiple access technique. During the HEW control period, the master station 102 may transmit a wake-up packet 500 to LP-WURs 112 which are included in HEW stations 104 and/or IoT devices 108 using one or more HEW packets that embeds a wake-up packet 500. During the HEW control period, the LP-WUR 112 included in STAs 104 may operate on a sub-channel smaller than the operating range of the master station 102. During the HEW control period, legacy stations refrain from communicating.

In accordance with some embodiments, during the master-sync transmission the LP-WUR 112 may receive a wake-up packet 500 and then may wake up the HEW STAs 104 or IoT STAs 108, which then may contend for the wireless medium with the legacy devices 106 being excluded from contending for the wireless medium during the master-sync transmission. In some embodiments, HEW STAs 104 or IoT STAs 108 may communicate with the master station 102 in accordance with a non-contention based access technique after being woken up and obtaining the UL transmit configuration from a trigger packet which may indicate an uplink (UL) UL-MU-MIMO and/or UL OFDMA control period.

In some embodiments, the multiple-access technique used during the HEW control period may be a scheduled OFDMA technique, although this is not a requirement. In some embodiments, the multiple access technique may be a time-division multiple access (TDMA) technique or a frequency division multiple access (FDMA) technique. In some embodiments, the multiple access technique may be a space-division multiple access (SDMA) technique.

The master station 102 may also communicate with legacy stations 106 and/or HEW stations 104 in accordance with legacy IEEE 802.11 communication techniques. In some embodiments, the master station 102 may also be configurable to transmit a wake-up packet to LP-WUR 112 outside the HEW control period in accordance with legacy IEEE 802.11 communication techniques, although this is not a requirement. In this case, the wake-up packet may comprise a legacy wake-up pulse with a 4 MHz bandwidth. In some embodiments, HEW devices may be legacy devices to LRLP devices. The LP-WUR 112 may be embedded in LRLP devices.

In example embodiments, an LP-WUR 112 and/or master station 102, HEW station 104, legacy station 106, IoT devices 108, and/or sensor hub 110, each of which may include a LP-WUR 112, may be configured to perform the methods and functions herein described in conjunction with FIGS. 1-8.

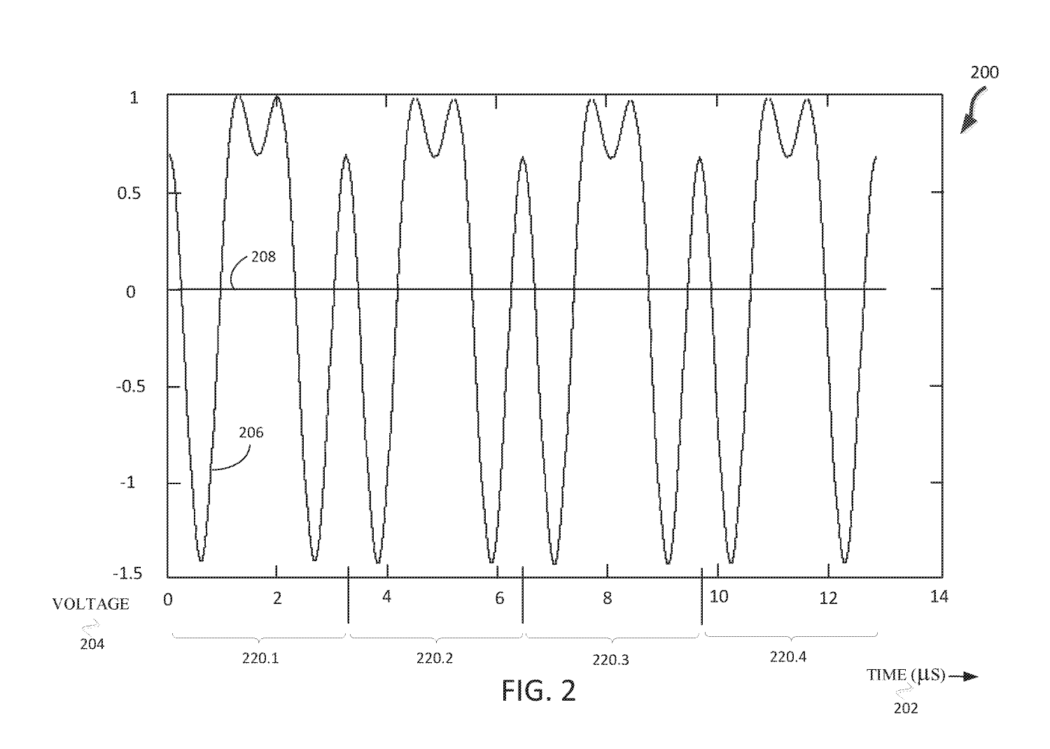

FIG. 2 illustrates time domain samples of a wake-up pulse 200 in accordance with some embodiments. Illustrated in FIG. 2 is time 202 along the horizontal axis, voltage 204 along the vertical axis, time domain samples of a real part 206, and time domain samples of an imaginary part 208. The wake-up pulse 200 is generated from a sequence of tones s_ax_real, where s_ax_real=sqrt(1/6)*[1, 0, 0, 0, 1, 0, 0, 0, −1, 0, 0, 0, 0, 0, 0, 0, 0, −1, 0, 0, 0, 1, 0, 0, 0, 1]. A 256 Inverse Fast Fourier Transform (IFFT) is used on the tones s_ax_real, which creates four 3.2 μsec patterns 220 with a total duration of 12.8 μsec. S_ax_real is a time domain sequence with a pattern 220 that repeats four times. The four patterns 220.1, 220.2, 220.3, and 220.4 are each 3.2 μsec. In some embodiments, to keep the pulse duration the same as a legacy OFDM symbol, only one period 220 out of the four periods 220.1, 220.2, 220.3, and 220.4 is considered to generate a 3.2 μsec pulse. In some embodiments the 4x symbol (12.8 μsec) duration is used compared with a legacy symbol duration of 3.2 μsec. The 26 tones of s_ax_real may be transmitted in accordance with OFDMA in a resource unit (RU) with 26 data sub-carriers. In some embodiments, the RU with 26 sub-carriers has a sub-carrier spacing of 312.5 KHz/4 for a bandwidth of the RU or sub-channel of 2.03125 MHz.

In some embodiments, a LP WU-pulse is modified to fill 13-tones with a 64-pt FFT. For example, the sequence of tones, s given below, may be based on an IEEE 802.11a Short Training Field (STF) with zero tones removed. S=sqrt(13/6)*(1+1i, −1−1i, 1+1i, −1−1i, −1−1i, 1+1i, 0, −1−1i, −1−1i, 1+1i, 1+1i, 1+1i, 1+1i) may be termed a Legacy Pulse.

In some embodiments, only half of the tones of the Legacy Pulse are used. In some embodiments, only half of the tones of the Legacy Pulse are used to be in conformance with the IEEE 802.11ax 26-tone bandwidth. By using only half of the tones, the bandwidth may be reduced from 4.06 MHz to 2.03125 MHz. In some embodiments, three nulls are inserted in between each tone to obtain ¼th of the IEEE 802.11ac sub-carrier spacing, which is similar to IEEE 802.11ax. This results in half of (13-tone*4), which equals 26 tones. S_ax is an example of a tone sequence derived from a Legacy Pulse sequence, where s_ax=sqrt(1/2/6)*(1+1i, 0, 0, 0, 1+1i, 0, 0, 0, −1−1i, 0, 0, 0, 0, 0, 0, 0, 0, −1−1i, 0, 0, 0, 1+1i, 0, 0, 0, 1+1i). s_ax_real may be derived from s_ax by replacing the complex values in s_ax with real values of plus or minus 1.

Because of the even symmetry in s_ax_real, e.g., sqrt(1/6)*[1 1 −1 0 −1 1 1] (for 64-point FFT) or sqrt(1/6)*[1, 0, 0, 0, 1, 0, 0, 0, −1, 0, 0, 0, 0, 0, 0, 0, 0, −1, 0, 0, 0, 1, 0, 0, 0, 1] (256-point FFT), is also real as illustrated in FIG. 2. A 64-point FFT may be used for the first tone sequence and a 256-point FFT may be used for the second tone sequence. The resulting time domain sequence after IFFT be a wake-up pulse used in generation of a wake up packet.

In some embodiments, the scaling factor in s_ax and s_ax_real is set such that the total power of the time domain signal equal to or similar to legacy IEEE 802.11n/ac/ax L-STF definitions. In some embodiments, the factor sqrt(13/6) is changed to 1/sqrt(2×6) and 1/sqrt(6), for complex s_ax and real s_ax_real, respectively.

In some embodiments, 64-point IFFT is used, s_ax_64 can as disclosed below to generate a 3.2 μsec pulse. S_ax_64=sqrt(1/2/6)*(1+1i, 1+1i, −1−1i, 0, −1−1i, 1+1i, 1+1i).

In some embodiments, the complex values in s_ax_64 are replaced with real values of plus or minus 1's as follows yielding: s_ax_64_real=sqrt(1/6)*(1, 1, −1, 0, −1, 1, 1).

In some embodiments, the LP WU-pulse may be modified to fill a 52-tone RU. In some embodiments, three nulls are inserted appropriate scaling is applied. S_ax_52=sqrt(1/2/12)*(0, 0, 0, 1+1i, 0, 0, 0, −1−1i, 0, 0, 0, 1+1i, 0, 0, 0, −1−1i, 0, 0, 0, −1−1i, 0, 0, 0, 1+1i, 0, 0, 0, 0, 0, 0, 0, −1−1i, 0, 0, 0, −1−1i, 0, 0, 0, 1+1i, 0, 0, 0, 1+1i, 0, 0, 0, 1+1i, 0, 0, 0, 1+1i). S_ax_52 may be prepended by an additional 5 zeros to both meet the required guard tones defined in IEEE 802.11ax 20 MHz OFDMA structure, and to generate 12.8 μsec periodic time domain signal with its period equal to 3.2 μsec.

In some embodiments, the wake-up packet 500 (see FIG. 5) may encode an identifier 514 of the LP-WUR 112. In some embodiments, the wake-up packet 500 is encoded by transmitting or not transmitting the wake-up pulse 200 one or more times. For example, each of the patterns 220 may be transmitted or not transmitted and may be used to encode zeros and ones. Alternative, the entire wake-up pulse 200 may be transmitted or not transmitted and may be used to encode zeros and ones for the identifier. In some embodiments, either the entire wake-up pulse 200 or portions of the wake-up pulse 200 may be transmitted by a pattern to indicate an identifier of the LP-WUR.

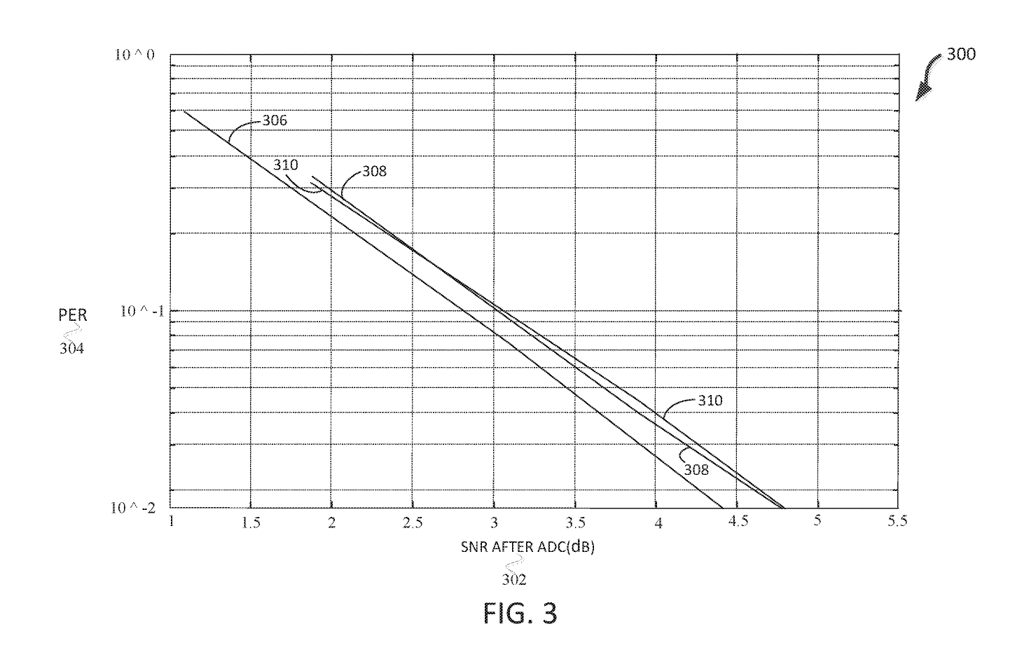

FIG. 3 illustrates a simulation 300 to compare the performance of the disclosed 2 MHz pulses with a legacy 4 MHz pulses. Illustrated in FIG. 3 is signal to noise ratio (SNR) along a horizontal axis, packet error rate (PER) 304 along a vertical axis, legacy 4 MHz pulse 306, 2 MHz real pulse (s_ax_real) 308, and 2 MHz complex pulse (s_ax) 310. The simulation for the legacy 4 MHz pulse 306 did not change the legacy filtering of the 4 MHz. In some embodiments, changing the receive filter in LP-WUR to 2 MHz can potentially provide an extra 3 dB gain in noise band. The results illustrated in FIG. 3 are obtained by using a channel model in accordance with IEEE 802.11n model D.

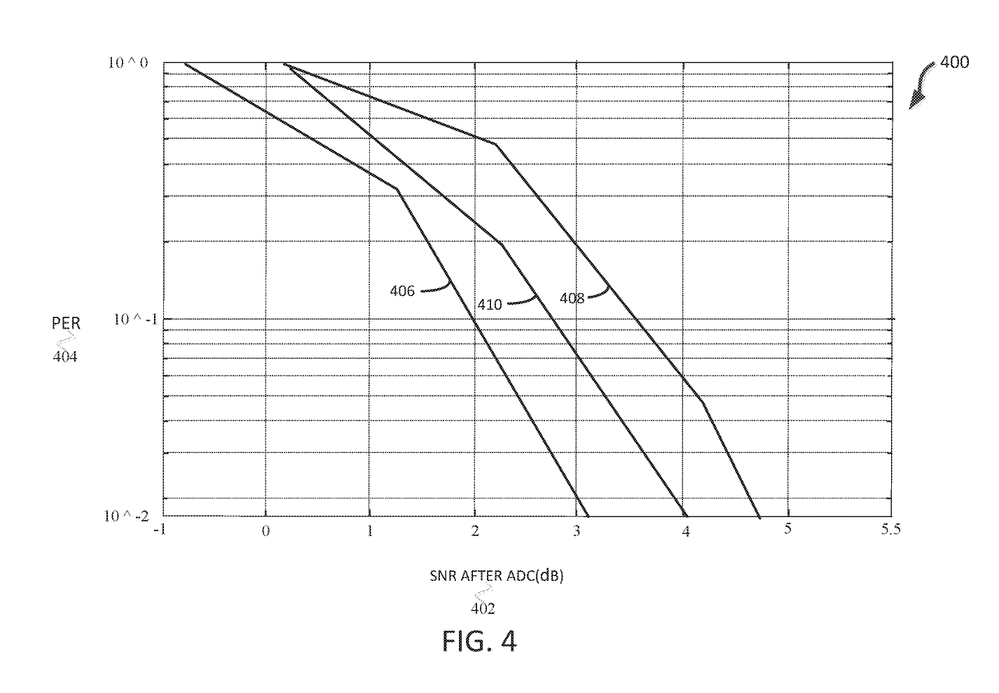

FIG. 4 illustrates a simulation 400 to compare the performance of the disclosed 2 MHz pulses with legacy 4 MHz pulses with additive white Gaussian noise (AWGN). Illustrated in FIG. 4 is SNR along a horizontal axis, PER 404 along a vertical axis, legacy 4 MHz pulse 406, 2 MHz real pulse (s_ax_real) 408, and 2 MHz complex pulse (s_ax) 410. Six thousand instantiations of AWGN channel were simulated.

In both FIGS. 3 and 4 the PER 304, 404 is slightly increased for the disclosed 2 MHz real pulse (s_ax_real) 308, 408 and 2 MHz complex pulse (s_ax) 310, 410 in comparison with the legacy 4 MHz pulse 306, 406. The LP-WUR may compensate for this because the LP-WUR may receive a 3 dB noise bandwidth gain with the smaller bandwidth of the 2 MHz real pulse (s_ax_real) 308, 408 and 2 MHz complex pulse (s_ax) 310, 410.

FIG. 5 illustrates a LP-WUR packet 500 in accordance with some embodiments. The LP-WUR packet 500 may include a preamble 502 and a payload 512. The preamble 502 may include a preamble in accordance with IEEE 802.11 such as a physical (PHY) field and a signal field. In some embodiments, the preamble 502 includes a legacy short-training field (L-STF), a legacy long training field (L-LTF), a legacy signal (L-SIG) field, and may include other fields such as a high-efficiency (HE) signal field. In some embodiments the preamble 502 includes the entire 1× symbol part of the IEEE 802.11ax preamble.

The WU-LPR 112 may ignore the preamble 502. The preamble 502 may be transmitted on a wider channel than the payload 512. For example, the preamble 502 may be transmitted on a 20 MHz channel and the payload 512 may be transmitted on a 2.03125 MHz, 4.0625 MHz, or 8.28125 MHz channel. In some embodiments, the LP-WUR packet 500 may be transmitted in a central portion of the channel the preamble 502 is transmitted on. The payload 512 may use a different modulation such as on/off key (OOK) or frequency shift key (FSK). The payload 512 includes a wake-up preamble 504, MAC header 506, frame body 508 including an identifier 514, and a frame check sequence (FCS) 510.

The wake-up preamble 504 may be a sequence of wake-up pulses 200 as described in conjunction with FIG. 2. The wake-up preamble 504 may be generated by OOK modulation of a pattern (e.g., [1 1 0 . . . 1 0]). For each 1 in the pattern, the pulse is transmitted and for each 0 in the pattern, the pulse is not transmitted, in accordance with some embodiments.

The MAC header 506 may be a header that includes a source and destination address. The frame body 508 may be the body of the frame that includes the identifier 508. The identifier 508 may be an identifier of one or more LP-WURs 112. The identifier 508 may indicate that the LP-WUR packet 500 is for the one or more LP-WURs 112 with the identifier 508. In some embodiments, the identifier 514 is comprised of one or more wake-up pulses 200 that encode the identifier 508 based on the wake-up pulse 200 be transmitted or not being transmitted. The FCS 510 may include information for the LP-WUR 112 to check the integrity of the payload 512. In some embodiments, the identifier 514 may be termed a wake-up identifier 514.

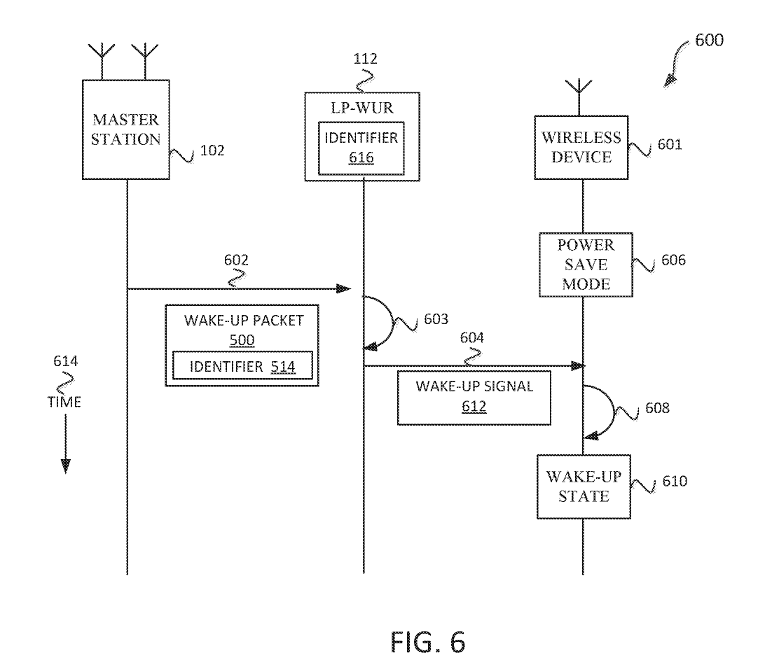

FIG. 6 illustrates a method 600 of waking up a wireless device in accordance with some embodiments. Illustrated in FIG. 6 is time 614 along a vertical axis and a master station 102, LP-WUR 112, and HEW station 104 along a horizontal axis. The master station 102 be a different wireless device. The wireless device 601 may be master station 102, legacy device 106, HEW station 104, IoT device 108, and/or a BlueTooth® device. The method 600 begins with operation 602 with the master station 102 transmitted a wake-up packet 500 to the LP-WUR 112. The wake-up packet 500 may include an identifier 514. The LP-WUR 112 may receive the wake-up packet 500. The method 600 continues at operation 603 with the LP-WUR 112 comparing the identifier 514 with the identifier 616. If the identifiers match, then the method 600 continues at operation 604 with the LP-WUR 112 sending a wake-up signal 612 to the HEW station 104. The LP-WUR 112 and wireless device 601 may be part of the same apparatus. The method 600 continues at operation 608 with the wireless device 601 receiving the wake-up signal 612 and determining based on the receipt of the wake-up signal 612 to go from a power save mode 606 to a wake-up state 610. The method 600 may end with the wireless device 601 in the wake-up state 610. The wireless device 601 may be ready to perform IEEE 802.11 frame exchange or Bluetooth™ frame exchanges with another wireless device (e.g, a master station 102 or Bluetooth™ device).

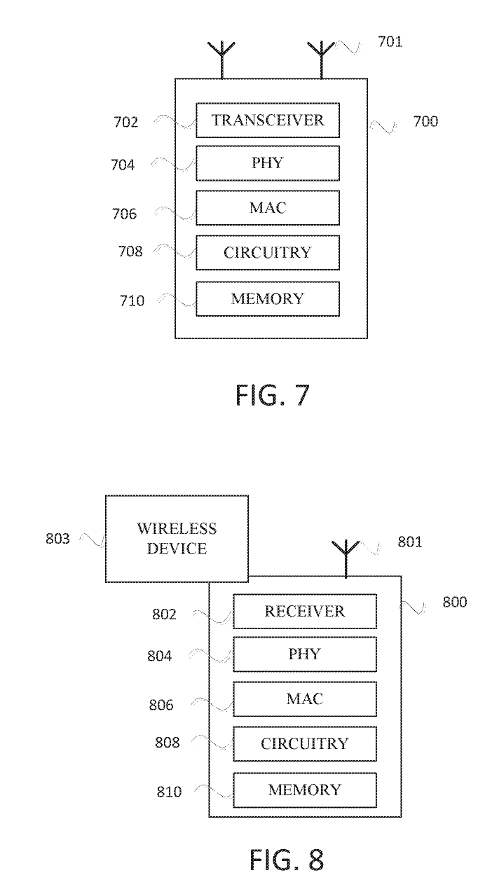

FIG. 7 illustrates a HEW device 700 in accordance with some embodiments. HEW device 700 may be an HEW compliant device that may be arranged to communicate with one or more other HEW devices, such as HEW STAs 104 (FIG. 1) or master station 102 (FIG. 1) as well as communicate with legacy devices 106 (FIG. 1). HEW STAs 104 and legacy devices 106 may also be referred to as HEW devices and legacy STAs, respectively. HEW device 700 may be suitable for operating as master station 102 (FIG. 1) or a HEW STA 104 (FIG. 1). In accordance with embodiments, HEW device 700 may include, among other things, a transmit/receive element 701 (for example an antenna), a transceiver 702, physical (PHY) circuitry 704, and media access control (MAC) circuitry 706. PHY circuitry 704 and MAC circuitry 706 may be HEW compliant layers and may also be compliant with one or more legacy IEEE 802.13 standards. MAC circuitry 706 may be arranged to configure packets such as a physical layer convergence procedure (PLCP) protocol data unit (PPDUs) and arranged to transmit and receive PPDUs, among other things. HEW device 700 may also include circuitry 708 and memory 710 configured to perform the various operations described herein. The circuitry 708 may be coupled to the transceiver 702, which may be coupled to the transmit/receive element 701. While FIG. 7 depicts the circuitry 708 and the transceiver 702 as separate components, the circuitry 708 and the transceiver 702 may be integrated together in an electronic package or chip.

In some embodiments, the MAC circuitry 706 may be arranged to contend for a wireless medium during a contention period to receive control of the medium for the HEW control period and configure an HEW PPDU. In some embodiments, the MAC circuitry 706 may be arranged to contend for the wireless medium based on channel contention settings, a transmitting power level, and a CCA level.

The PHY circuitry 704 may be arranged to transmit the HEW PPDU. The PHY circuitry 704 may include circuitry for modulation/demodulation, upconversion/downconversion, filtering, amplification, etc. In some embodiments, the circuitry 708 may include one or more processors. The circuitry 708 may be configured to perform functions based on instructions being stored in a RAM or ROM, or based on special purpose circuitry. The circuitry 708 may include processing circuitry and/or transceiver circuitry in accordance with some embodiments. The circuitry 708 may include a processor such as a general purpose processor or special purpose processor. The circuitry 708 may implement one or more functions associated with transmit/receive elements 701, the transceiver 702, the PHY circuitry 704, the MAC circuitry 706, and/or the memory 710.

In some embodiments, the circuitry 708 may be configured to perform one or more of the functions and/or methods described herein and/or in conjunction with FIGS. 1-8.

In some embodiments, the transmit/receive elements 701 may be two or more antennas that may be coupled to the PHY circuitry 704 and arranged for sending and receiving signals including transmission of the HEW packets. The transceiver 702 may transmit and receive data such as HEW PPDU and packets that include an indication that the HEW device 700 should adapt the channel contention settings according to settings included in the packet. The memory 710 may store information for configuring the other circuitry to perform operations for configuring and transmitting HEW packets and performing the various operations to perform one or more of the functions and/or methods described herein and/or in conjunction with FIGS. 1-8.

In some embodiments, the HEW device 700 may be configured to communicate using OFDM communication signals over a multicarrier communication channel. In some embodiments, HEW device 700 may be configured to communicate in accordance with one or more specific communication standards, such as the Institute of Electrical and Electronics Engineers (IEEE) standards including IEEE 802.11-2012, 802.11n-2009, 802.11ac-2013, 802.11ax, DensiFi, standards and/or proposed specifications for WLANs, or other standards as described in conjunction with FIG. 1, although the scope of the invention is not limited in this respect as they may also be suitable to transmit and/or receive communications in accordance with other techniques and standards. In some embodiments, the HEW device 700 may use 4× symbol duration of 802.11n or 802.11ac.

In some embodiments, an HEW device 700 may be part of a portable wireless communication device, such as a personal digital assistant (PDA), a laptop or portable computer with wireless communication capability, a web tablet, a wireless telephone, a smartphone, a wireless headset, a pager, an instant messaging device, a digital camera, an access point, a television, a medical device (e.g., a heart rate monitor, a blood pressure monitor, etc.), an access point, a base station, a transmit/receive device for a wireless standard such as 802.11 or 802.16, or other device that may receive and/or transmit information wirelessly. In some embodiments, the mobile device may include one or more of a keyboard, a display, anon-volatile memory port, multiple antennas, a graphics processor, an application processor, speakers, and other mobile device elements. The display may be an LCD screen including a touch screen.

The transmit/receive element 701 may comprise one or more directional or omnidirectional antennas, including, for example, dipole antennas, monopole antennas, patch antennas, loop antennas, microstrip antennas or other types of antennas suitable for transmission of RF signals. In some multiple-input multiple-output (MIMO) embodiments, the antennas may be effectively separated to take advantage of spatial diversity and the different channel characteristics that may result.

Although the HEW device 700 is illustrated as having several separate functional elements, one or more of the functional elements may be combined and may be implemented by combinations of software-configured elements, such as processing elements including digital signal processors (DSPs), and/or other hardware elements. For example, some elements may comprise one or more microprocessors, DSPs, field-programmable gate arrays (FPGAs), application specific integrated circuits (ASICs), radio-frequency integrated circuits (RFICs) and combinations of various hardware and logic circuitry for performing at least the functions described herein. In some embodiments, the functional elements may refer to one or more processes operating on one or more processing elements.

Some embodiments may be implemented fully or partially in software and/or firmware. This software and/or firmware may take the form of instructions contained in or on a non-transitory computer-readable storage medium. Those instructions may then be read and executed by one or more processors to enable performance of the operations described herein. Those instructions may then be read and executed by one or more processors to cause the device 700 to perform the methods and/or operations described herein. The instructions may be in any suitable form, such as but not limited to source code, compiled code, interpreted code, executable code, static code, dynamic code, and the like. Such a computer-readable medium may include any tangible non-transitory medium for storing information in a form readable by one or more computers, such as but not limited to read only memory (ROM); random access memory (RAM); magnetic disk storage media; optical storage media; a flash memory, etc.

FIG. 8 illustrates a LP-WUR 800 in accordance with some embodiments. In some embodiments, the wireless device 803 may be a master station 102, HEW station 104, Bluetooth™ device, legacy station 106, IoT devices 108, and/or sensor hub 110.

The LP-WUR 800 may be included in an HEW compliant device that may be arranged to communicate with one or more other HEW devices, such as HEW STAs 104 (FIG. 1) or master station 102 (FIG. 1) as well as communicate with legacy devices 106 (FIG. 1) or Bluetooth™ devices.

In accordance with embodiments, LP-WUR 800 may include, among other things, a receive element 801 (for example an antenna), a receiver 802, physical (PHY) circuitry 804, and media access control (MAC) circuitry 806.

In some embodiments, the LP-WUR 800 includes only one receive element 801. In some embodiments, the LP-WUR 800 is not able to transmit, but only receive signals. The LP-WUR 800 may have an on state where it listens to the signals to receive a wake-up packet 500. Some embodiments provide a solution to a problem of enabling wireless devices to be woken up while using small amounts of power in a sleep state.

The PHY circuitry 804 and MAC circuitry 806 may be compliant with one or more wireless standards such as IEEE 802.11 standards and/or Bluetooth™ MAC circuitry 706 may be arranged to decode packet to determine if the packet includes the identifier 616 (FIG. 6) of the LP-WUR 800 device.

In some embodiments, the PHY circuitry 804 and MAC circuitry 806 are configured to decode a wake-up packet 500 encoded with OOK. In some embodiments, the MAC circuitry 806 may be configured to decode an identifier of the wake-up packet 500. In some embodiments, the PHY circuitry 804 and/or the MAC circuitry 806 may only be configured to decode the wake-up packet 500 and ⁻to decode the identifier of the wake-up packet 500.

HEW device 800 may also include circuitry 808 and memory 810 configured to perform the various operations described herein such as determining if a packet includes the wake-up signal 612, the identifier 616, and generating a wake-up signal 612. The LP-WUR 808 may be coupled to the receiver 802, which may be coupled to the receive element 801. While FIG. 8 depicts the circuitry 808 and the transceiver 802 as separate components, the circuitry 808 and the receiver 802 may be integrated together in an electronic package or chip and may be integrated together with 708, similarly 802 may be integrated with 702, 804 integrated with 704, 806 integrated with 706, and 810 integrated with 710

The circuitry 808 may be communicatively coupled to the wireless device 700 to send the wake-up signal 612. The circuitry 808 may be configured to send a signal transmission (e.g., the wake-up signal 612) to a co-located device (e.g., 803) over internal circuits such as a internal BUS or wire. The PHY circuitry 804 may include circuitry for demodulation, downconversion, filtering, amplification, etc. In some embodiments, the circuitry 808 may include one or more processors. The circuitry 808 may be configured to perform functions based on instructions being stored in a RAM or ROM, or based on special purpose circuitry. The circuitry 808 may include processing circuitry and/or receiver circuitry in accordance with some embodiments. The circuitry 808 may include a processor such as a general purpose processor or special purpose processor. The circuitry 808 may implement one or more functions associated with receive elements 801, the receiver 802, the PHY circuitry 804, the MAC circuitry 806, and/or the memory 810.

In some embodiments, the circuitry 808 may be configured to perform one or more of the functions and/or methods described herein and/or in conjunction with FIGS. 1-8.

The memory 810 may store information for configuring the other circuitry to perform operations for configuring and sending wake-up signal 612 and performing the various operations to perform one or more of the functions and/or methods described herein and/or in conjunction with FIGS. 1-8.

In some embodiments, the LP-WUR 800 may be configured to communicate using OFDM communication signals over a multicarrier communication channel to receive the wake-up packet 500. In some embodiments, HEW device 700 may be configured to communicate in accordance with one or more specific communication standards, such as the Institute of Electrical and Electronics Engineers (IEEE) standards including IEEE 802.11-2012, 802.11n-2009, 802.11ac-2013, 802.11ax, standards and/or proposed specifications for WLANs, or other standards as described in conjunction with FIG. 1, although the scope of the invention is not limited in this respect as they may also be suitable to receive communications in accordance with other techniques and standards.

In some embodiments, LP-WUR 800 may be part of the wireless device 803 which may be part of a portable wireless communication device, such as a personal digital assistant (PDA), a laptop or portable computer with wireless communication capability, a web tablet, a wireless telephone, a smartphone, a wireless headset, a pager, an instant messaging device, a digital camera, an access point, a television, a medical device (e.g., a heart rate monitor, a blood pressure monitor, etc.), an access point, a base station, a transmit/receive device for a wireless standard such as 802.11 or 802.16, or other device that may receive and/or transmit information wirelessly. In some embodiments, the mobile device may include one or more of a keyboard, a display, a non-volatile memory port, multiple antennas, a graphics processor, an application processor, speakers, and other mobile device elements. The display may be an LCD screen including a touch screen.

Although the LP-WUR 800 is illustrated as having several separate functional elements, one or more of the functional elements may be combined and may be implemented by combinations of software-configured elements, such as processing elements including digital signal processors (DSPs), and/or other hardware elements. For example, some elements may comprise one or more microprocessors, DSPs, field-programmable gate arrays (FPGAs), application specific integrated circuits (ASICs), radio-frequency integrated circuits (RFICs) and combinations of various hardware and logic circuitry for performing at least the functions described herein. In some embodiments, the functional elements may refer to one or more processes operating on one or more processing elements.

Although the LP-WUR 800 is illustrated as having separate elements than the wireless device 803, in some embodiments, the LP-WUR 800 and wireless device 802 may share some elements. For example, the LP-WUR 800 may use one of the transmit/receive elements 701 illustrated in FIG. 7 as well as the memory 710.

Some embodiments may be implemented fully or partially in software and/or firmware. This software and/or firmware may take the form of instructions contained in or on anon-transitory computer-readable storage medium. Those instructions may then be read and executed by one or more processors to enable performance of the operations described herein. Those instructions may then be read and executed by one or more processors to cause the device 700 to perform the methods and/or operations described herein. The instructions may be in any suitable form, such as but not limited to source code, compiled code, interpreted code, executable code, static code, dynamic code, and the like. Such a computer-readable medium may include any tangible non-transitory medium for storing information in a form readable by one or more computers, such as but not limited to read only memory (ROM); random access memory (RAM); magnetic disk storage media; optical storage media, a flash memory, etc.

The following examples pertain to further embodiments. Example 1 is an apparatus of an access point. The apparatus comprising a memory, and processing circuitry coupled to the memory. The processing circuitry configured to: encode one or more wake-up packets to be transmitted on one or more sub-channels to one or more low-power wake-up receivers (LP-WURs), wherein each of the one or more wake-up packets are to be 26 data tones or 52 data tones, and wherein each of the one or more wake-up packets comprises one or more wake-up pulses; and cause to be transmitted the one or more wake-up packets in accordance with orthogonal frequency division multiple access (OFDMA) on the one or more sub-channels.

In Example 2, the subject matter of Example 1 can optionally include where the bandwidth of the one or more sub-channels is one from the following group: 2.03125 MHz for 26 data tones, 4.0623 MHz for 52 data tones, a bandwidth that comprises exactly 26 data tones, a second bandwidth that comprises exactly 52 data tones, approximately 2.03125 MHz for 26 data tones, approximately 4.0623 MHz for 52 data tones, and 26 data tones that straddle a DC subcarrier at the center of the sub-channel with null tones at and around the DC.

In Example 3, the subject matter of Examples 1 or 2 can optionally include where each of the one or more wake-up pulses comprises one or more patterns, wherein each pattern is a sequence of one or more on and off keying modulations.

In Example 4, the subject matter of any of Examples 1-3 can optionally include where a number of the one or more wake-up pulses is four each with a duration of 3.2 μseconds (μs).

In Example 5, the subject matter of any of Examples 1-4 can optionally include where the processing circuitry is configured to: encode a legacy short-training field (L-STF), a legacy long training field (L-LTF), a legacy signal (L-SIG) field, a repeated L-SIG (R-L-SIG), a high-efficiency (HE) signal A (HE-SIG-A), and an HE SIG B (HE-SIG-B) before the wake-up packet and wherein the L-STF, L-LTF, L-SIG, R-L-SIG, HE-SIG-A, and FIE-SIG-B are to be transmitted on a 20 MHz bandwidth.

In Example 6, the subject matter of any of Examples 1-5 can optionally include where the processing circuitry is further configured to: encode a wake-up identifier in at least one of the one or more wake-up packets comprising one or more second wake-up pulses, wherein the wake-up identifier is to be encoded using a series of on patterns and off patterns comprising the one or more second wake-pulses.

In Example 7, the subject matter of any of Examples 1-6 can optionally include where tones of the one or more wake-up pulses are to be a square root of (1/(2 times 6)) times [1+1i, 0, 0, 0, 1+1i, 0, 0, 0, −1−1I, 0, 0, 0, 0, 0, 0, 0, 0, −1−1i, 0, 0, 0, 1+1i, 0, 0, 0, 1+1i] and wherein an inverse Fast Fourier Transform is applied to the one or more tones to generate a symbol duration of four times a legacy duration of 3.2 μseconds (μs).

In Example 8, the subject matter of any of Examples 1-7 can optionally include where a 256 inverse Fast Fourier Transform (IFFT) is to be used on the 26 data tones, and wherein the IFFT is to generate a 3.2μ second time domain sequence that is to be repeated four times, and wherein a tone spacing for the 26 data tones and the 52 data tones is 78.125 KHz per carrier.

In Example 9, the subject matter of any of Examples 1-8 can optionally include where one or more tones of the one or more wake-up pulses are to be a square root of (1/6) times [1, 0, 0, 0, 1, 0, 0, 0, −1, 0, 0, 0, 0, 0, 0, 0, 0, −1, 0, 0, 0, 1, 0, 0, 0, 1] and wherein an inverse Fast Fourier Transform is applied to the one or more tones to generate a symbol duration of four times a legacy duration of 3.2 μseconds (μs).

In Example 10, the subject matter of any of Examples 1-9 can optionally include where one or more tones of the one or more wake-up pulses are to be square root of (1/(2/6)) times [1+1i, 1+1i, −1−1i, 0, −1−1i, 1+1i, 1+1i].

In Example 11, the subject matter of any of Examples 1-10 can optionally include where the processing circuitry is configured to:use a 64 inverse Fast Fourier Transform (IFFT) on the 26 data tones or the 52 data tones to generate a 3.2μ second time domain sequence.

In Example 12, the subject matter of any of Examples 1-11 can optionally include where one or more tones of the one or more wake-up pulses are to be square root of (1/6) time [1, 1, −1, 0, −1, 1, 1] with a symbol duration of a legacy duration of 3.2 μseconds (μs).

In Example 13, the subject matter of any of Examples 1-12 can optionally include where the wake-up packet indicates that one or more stations are to exit a power save mode.

In Example 14, the subject matter of any of Examples 1-13 can optionally include where the one or more wake-up packets each encode one or more wake-up identifiers and wherein the one or more wake-up identifiers are each one from the following group: an identifier generated when the station associates with the wireless local-area network device, a group identifier identifying a group of stations, a unique signage generated when the station associates with the wireless local-area network device, and a unique signage generated based on association parameters when the station associates with the wireless local-area network device.

In Example 15, the subject matter of any of Examples 1-14 can optionally include where the access point is one from the following group: an institute of Electrical and Electronic Engineers (IEEE) 802.11ax access point, a sensor hub, an IEEE 802.11ax sensor hub, an IEEE 802.11ax station, and an access gateway.

In Example 16, the subject matter of any of Examples 1-15 can optionally include one or more antennas coupled to the processing circuitry.

Example 17 is a non-transitory computer-readable storage medium that stores instructions for execution by one or more processors, the instructions to configure the one or more processors to cause a wireless device to: encode one or more wake-up packets to be transmitted on one or more sub-channels to one or more low-power wake-up receivers (LP-WURs), wherein each of the one or more wake-up packets are to be 26 data tones or 52 data tones, and wherein the one or more wake-up packets comprises one or more wake-up pulses; and cause to be transmitted the one or more wake-up packets in accordance with orthogonal frequency division multiple access (OFDMA) on the one or more sub-channels.

In Example 18, the subject matter of any of Examples 1-3 can optionally include where the bandwidth of the one or more sub-channels is one from the following group: 2.03125 MHz for 26 data tones, 4.0623 MHz for 52 data tones, a bandwidth that comprises exactly 26 data tones, a second bandwidth that comprises exactly 52 data tones, approximately 2.03125 MHz for 26 data tones, approximately 4.0623 MHz for 52 data tones, and 26 data tones that straddle a DC subcarrier at the center of the sub-channel with null tones at and around the DC.

Example 19 is a method performed by a wireless device. The method comprising: encoding one or more wake-up packets to be transmitted on one or more sub-channels to one or more low-power wake-up receivers (LP-WURs), wherein each of the one or more wake-up packets are to be 26 data tones or 52 data tones, and wherein the wake-up packet comprises one or more wake-up pulses; and causing to be transmitted the one or more wake-up packets in accordance with orthogonal frequency division multiple access (OFDMA) on the one or more sub-channels.

In Example 20, the subject matter of Example 19 can optionally include where the bandwidth of the one or more sub-channels is one from the following group: 2.03125 MHz for 26 data tones, 4.0623 MHz for 52 data tones, a bandwidth that comprises exactly 26 data tones, a second bandwidth that comprises exactly 52 data tones, approximately 2.03125 MHz for 26 data tones, approximately 4.0623 MHz for 52 data tones, and 26 data tones that straddle a DC subcarrier at the center of the sub-channel with null tones at and around the DC.

Example 21 is an apparatus of a low-power wake-up receiver (LP-WUR), the apparatus comprising a memory, and processing circuitry coupled to the memory, the processing circuitry configured to: decode a wake-up packet on a sub-channel, wherein the wake-up packet comprises one or more wake-up pulses, wherein each of the one or more wake-up pulses is to be 26 data tones or 52 data tones, and wherein the wake-up packet is to be received in accordance with ON/OFF keying modulation; and if the wake-up packet encodes an identifier of the LP-WUR, then the LP-WUR is to generate an exit a power save mode signal.

In Example 22, the subject matter of Example 22 can optionally include where the bandwidth of the one or more sub-channels is one from the following group: 2.03125 MHz for 26 data tones, 4.0623 MHz for 52 data tones, a bandwidth that comprises exactly 26 data tones, a second bandwidth that comprises exactly 52 data tones, approximately 2.03125 MHz for 26 data tones, and approximately 4.0623 MHz for 52 data tones.

In Example 23, the subject matter of Example 22 can optionally include where the wake-up packet comprises a number of wake-up pulses comprising one or more patterns, wherein each pattern is either an on pattern or an off pattern, and wherein each pattern has a duration of 3.2 μseconds (μs).

In Example 24, the subject matter of Example 22 can optionally include where the exit a power save mode signal is to cause a wireless device to exit the power save mode, wherein the wireless device is one from the following group: an Institute of Electrical and Electronic Engineers (IEEE) 802.11ax access point, a sensor hub, an IEEE 802.11ax sensor hub, an IEEE 802.11ax station, and a Bluetooth® device.

In Example 25A, the subject matter of any of Examples 21-24 can optionally include one or more antennas coupled to the processing circuitry.

In Example 25B, the subject matter of any of Examples 21-25A can optionally include where tones of the one or more wake-up pulses are to be square root of (1/(2 times 6)) times [1+1i, 0, 0, 0, 1+1i, 0, 0, 0, −1−1I, 0, 0, 0, 0, 0, 0, 0, 0, −1−1i, 0, 0, 0, 1+1i, 0, 0, 0, 1+1i] with a symbol duration of four times a legacy duration of 3.2 μseconds (μs).

Example 26 is an apparatus of an access point, the apparatus comprising: means for encoding one or more wake-up packets to be transmitted on one or more sub-channels to one or more low-power wake-up receivers (LP-WURs), wherein each of the one or more wake-up packets are to be 26 data tones or 52 data tones, and wherein each of the one or more wake-up packets comprises one or more wake-up pulses; and means for causing to be transmitted the one or more wake-up packets in accordance with orthogonal frequency division multiple access (OFDMA) on the one or more sub-channels.

In Example 27, the subject matter of Example 27 can optionally include where the bandwidth of the one or more sub-channels is one from the following group: 2.03125 MHz for 26 data tones, 4.0623 MHz for 52 data tones, a bandwidth that comprises exactly 26 data tones, a second bandwidth that comprises exactly 52 data tones, approximately 2.03125 MHz for 26 data tones, approximately 4.0623 MHz for 52 data tones, and 26 data tones that straddle a DC subcarrier at the center of the sub-channel with null tones at and around the DC.

In Example 28, the subject matter of Examples 26 or 27 can optionally include where each of the one or more wake-up pulses comprises one or more patterns, wherein each pattern is a sequence of one or more on and off keying modulations.

In Example 29, the subject matter of Example 28 can optionally include where a number of the one or more wake-up pulses is four each with a duration of 3.2 μseconds (μs).

In Example 30, the subject matter of any of Examples 26-29 can optionally include means for encoding a legacy short-training field (L-STF), a legacy long training field (L-LTF), a legacy signal (L-SIG) field, a repeated (R-L-SIG), a high-efficiency (HE) signal A (HE-SIG-A), and an HE SIG B (HE-SIG-B) before the wake-up packet and wherein the L-STF, L-LTF, L-SIG, R-L-SIG, HE-SIG-A, and HE-SIG-B are to be transmitted on a 20 MHz bandwidth.

In Example 31, the subject matter of any of Examples 26-30 can optionally include means for encoding a wake-up identifier in at least one of the one or more wake-up packets comprising one or more second wake-up pulses, wherein the wake-up identifier is to be encoded using a series of on patterns and off patterns comprising the one or more second wake-pulses.

In Example 32, the subject matter of any of Examples 26-31 can optionally include where tones of the one or more wake-up pulses are to be a square root of (1/(2 times 6)) times [1+1i, 0, 0, 0, 1+1i, 0, 0, 0, −1−1I, 0, 0, 0, 0, 0, 0, 0, 0, −1−1i, 0, 0, 0, 1+1i, 0, 0, 0, 1+1i] and wherein an inverse Fast Fourier Transform is applied to the one or more tones to generate a symbol duration of four times a legacy duration of 3.2 μseconds (μs).

In Example 33, the subject matter of any of Examples 26-32 can optionally include where a 256 inverse Fast Fourier Transform (IFFT) is to be used on the 26 data tones, and wherein the IFFT is to generate a 3.2μ second time domain sequence that is to be repeated four times, and wherein a tone spacing for the 26 data tones and the 52 data tones is 78.125 KHz per carrier.

In Example 34, the subject matter of any of Examples 26-33 can optionally include where one or more tones of the one or more wake-up pulses are to be a square root of (1/6) times [1, 0, 0, 0, 1, 0, 0, 0, −1, 0, 0, 0, 0, 0, 0, 0, 0, −1, 0, 0, 0, 1, 0, 0, 0, 1] and wherein an inverse Fast Fourier Transform is applied to the one or more tones to generate a symbol duration of four times a legacy duration of 3.2 μseconds (μs).

In Example 35, the subject matter of any of Examples 26-34 can optionally include where one or more tones of the one or more wake-up pulses are to be square root of (1/(2/6)) times [1+1i, 1+1i, −1−1i, 0, −1−1i, 1+1i, 1+1i].

In Example 36, the subject matter of any of Examples 26-35 can optionally include means for using a 64 inverse Fast Fourier Transform (IFFT) on the 26 data tones or the 52 data tones to generate a 3.2μ second time domain sequence.

In Example 37, the subject matter of any of Examples 26-36 can optionally include where one or more tones of the one or more wake-up pulses are to be square root of (1/6) time [1, 1, −1, 0, −1, 1, 1] with a symbol duration of a legacy duration of 3.2 μseconds (μs).

In Example 38, the subject matter of any of Examples 26-37 can optionally include where the wake-up packet indicates that one or more stations are to exit a power save mode.

In Example 39, the subject matter of any of Examples 26-38 can optionally include where the one or more wake-up packets each encode one or more wake-up identifiers and wherein the one or more wake-up identifiers are each one from the following group: an identifier generated when the station associates with the wireless local-area network device, a group identifier identifying a group of stations, a unique signage generated when the station associates with the wireless local-area network device, and a unique signage generated based on association parameters when the station associates with the wireless local-area network device.

In Example 40, the subject matter of any of Examples 26-39 can optionally include where the access point is one from the following group: an Institute of Electrical and Electronic Engineers (IEEE) 802.11ax access point, a sensor hub, an IEEE 802.11ax sensor hub, an IEEE 802.11ax station, and an access gateway.

In Example 41, the subject matter of any of Examples 26-40 can optionally include means for transmitting and receiving radio signals.

Example 42 is an apparatus of a low-power wake-up receiver (LP-WUR), the apparatus comprising: means for decoding a wake-up packet on a sub-channel, wherein the wake-up packet comprises one or more wake-up pulses, wherein each of the one or more wake-up pulses is to be 26 data tones or 52 data tones, and wherein the wake-up packet is to be received in accordance with ON/OFF keying modulation; and if the wake-up packet encodes an identifier of the LP-WUR, then means for the LP-WUR to generate an exit a power save mode signal.

In Example 43, the subject matter of Example 43 can optionally include where the bandwidth of the one or more sub-channels is one from the following group: 2.03125 MHz for 26 data tones, 4.0623 MHz for 52 data tones, a bandwidth that comprises exactly 26 data tones, a second bandwidth that comprises exactly 52 data tones, approximately 2.03125 MHz for 26 data tones, and approximately 4.0623 MHz for 52 data tones.

In Example 44, the subject matter of Example 43 can optionally include where the wake-up packet comprises a number of wake-up pulses comprising one or more patterns, wherein each pattern is either an on pattern or an off pattern, and wherein each pattern has a duration of 3.2 μseconds (μs).

In Example 45, the subject matter of Example 43 can optionally include where the exit a power save mode signal is to cause a wireless device to exit the power save mode, wherein the wireless device is one from the following group: an Institute of Electrical and Electronic Engineers (IEEE) 802.11ax access point, a sensor hub, an IEEE 802.11ax sensor hub, an IEEE 802.11ax station, and a Bluetooth® device.

In Example 46, the subject matter of any of Examples 42-45 can optionally include one or more antennas coupled to the processing circuitry.

Example 47 is a method performed by a low-power wake-up receiver (LP-WUR). The method comprising: decoding a wake-up packet on a sub-channel, wherein the wake-up packet comprises one or more wake-up pulses, wherein each of the one or more wake-up pulses is to be 26 data tones or 52 data tones, and wherein the wake-up packet is to be received in accordance with ON/OFF keying modulation; and generating an exit a power save mode signal by the LP-WUR if the wake-up packet encodes an identifier of the LP-WUR.

In Example 48, the subject matter of Example 48 can optionally include where the bandwidth of the one or more sub-channels is one from the following group: 2.03125 MHz for 26 data tones, 4.0623 MHz for 52 data tones, a bandwidth that comprises exactly data tones, a second bandwidth that comprises exactly 52 data tones, approximately 2.03125 MHz for 26 data tones, and approximately 4.0623 MHz for 52 data tones.

In Example 49, the subject matte of any of Example 47 can optionally include where the wake-up packet comprises a number of wake-up pulses comprising one or more patterns, wherein each pattern is either an on pattern or an off pattern, and wherein each pattern has a duration of 3.2 μseconds (μs).

In Example 50, the subject matter of Example 47 can optionally include where the exit a power save mode signal is to cause a wireless device to exit the power save mode, wherein the wireless device is one from the following group: an Institute of Electrical and Electronic Engineers (IEEE) 802.11ax access point, a sensor hub, an IEEE 802.11ax sensor hub, an IEEE 802.11ax station, and a Bluetooth® device.

Example 51 is a non-transitory computer-readable storage medium that stores instructions for execution by one or more processors, the instructions to configure the one or more processors to cause a wireless device to: decode a wake-up packet on a sub-channel, wherein the wake-up packet comprises one or more wake-up pulses, wherein each of the one or more wake-up pulses is to be 26 data tones or 52 data tones, and wherein the wake-up packet is to be received in accordance with ON/OFF keying modulation; and if the wake-up packet encodes an identifier of the then the LP-WUR is to generate an exit a power save mode signal.

In Example 52, the subject matter of Example 52 can optionally include where the bandwidth of the one or more sub-channels is one from the following group: 2.03125 MHz for 26 data tones, 4.0623 MHz for 52 data tones, a bandwidth that comprises exactly 26 data tones, a second bandwidth that comprises exactly 52 data tones, approximately 2.03125 MHz for 26 data tones, and approximately 4.0623 MHz for 52 data tones.

In Example 53, the subject matter of Example 52 can optionally include where the wake-up packet comprises a number of wake-up pulses comprising one or more patterns, wherein each pattern is either an on pattern or an off pattern, and wherein each pattern has a duration of 3.2 μseconds (μs).

In Example 54, the subject matter of Example 52 can optionally include where the exit a power save mode signal is to cause a wireless device to exit the power save mode, wherein the wireless device is one from the following group: an Institute of Electrical and Electronic Engineers (IEEE) 802.11ax access point, a sensor hub, an IEEE 802.11ax sensor hub, an IEEE 802.11ax station, and a Bluetooth® device.

The Abstract is provided to comply with 37 C.F.R. Section 1.72(b) requiring an abstract that will allow the reader to ascertain the nature and gist of the technical disclosure. It is submitted with the understanding that it will not be used to limit or interpret the scope or meaning of the claims. The following claims are hereby incorporated into the detailed description, with each claim standing on its own as a separate embodiment.

What is claimed is:

1. An apparatus of an access point, the apparatus comprising a memory, and processing circuitry coupled to the memory, the processing circuitry configured to:
encode one or more wake-up packets to be transmitted on one or more sub-channels to one or more low-power wake-up receivers (LP-WURs), wherein each of the one or more wake-up packets are to be 26 data tones or 52 data tones, and Wherein each of the one or more wake-up packets comprises one or more wake-up pulses; and
cause to be transmitted the one or more wake-up packets in accordance with orthogonal frequency division multiple access (OFDMA) on the one or more sub-channels

2. The apparatus of claim wherein the bandwidth of the one or more sub-channels is one from the following group: 2.03125 MHz for 26 data tones, 4.0623 MHz for 52 data tones, a bandwidth that comprises exactly 26 data tones, a second bandwidth that comprises exactly 52 data tones, approximately 2.03125 MHz for 26 data tones, approximately 4.0623 MHz for 52 data tones, and 26 data tones that straddle a DC subcarrier at the center of the sub-channel with null tones at and around the DC.

3. The apparatus of claim 1, wherein each of the one or more wake-up pulses comprises one or more patterns, wherein each pattern is a sequence of one or more on and off keying modulations.

4. The apparatus of claim 3, wherein a number of the one or more wake-up pulses is four each with a duration of 3.2 μseconds (μs).

5. The apparatus of claim 1, wherein the processing circuitry is configured to:
encode a legacy short-training field (L-STF), a legacy long training field (L-LTF), a legacy signal (L-SIG) field, a repeated L-SIG (R-L-SIG), a high-efficiency (HE) signal A (HE-SIG-A), and an HE SIG B (HE-SIG-B) before the wake-up packet and wherein the L-STF, L-LTF, L-SIG, R-L-SIG, HE-SIG-A, and HE-SIG-B are to be transmitted on a 20 MHz bandwidth.

6. The apparatus of claim 1, wherein the processing circuitry is further configured to:
encode a wake-up identifier in at least one of the one or more wake-up packets comprising one or more second wake-up pulses, wherein the wake-up identifier is to be encoded using a series of on patterns and off patterns comprising the one or more second wake-pulses.

7. The apparatus of claim 1, wherein tones of the one or more wake-up pulses are to be a square root of (1/(2 times 6)) times [1+1i, 0, 0, 0, 1+1i, 0, 0, 0, −1−1I, 0, 0, 0, 0, 0, 0, 0, 0, −1−1i, 0, 0, 0, 1+1i, 0, 0, 0, 1+1i] and wherein an inverse Fast Fourier Transform is applied to the one or more tones to generate a symbol duration of four times a legacy duration of 3.2 μseconds (μs).

8. The apparatus of claim 1, wherein a 256 inverse Fast Fourier Transform (IFFT) is to be used on the 26 data tones, and wherein the IFFT is to generate a 3.2μ second time domain sequence that is to be repeated four times, and wherein a tone spacing for the 26 data tones and the 52 data tones is 78.125 KHz per carrier.

9. The apparatus of claim 1, wherein one or more tones of the one or more wake-up pulses are to be a square root of (1/6) times [1, 0, 0, 0, 1, 0, 0, 0, −1, 0, 0, 0, 0, 0, 0, 0, 0, −1, 0, 0, 0, 1, 0, 0, 0, 1] and wherein an inverse Fast Fourier Transform is applied to the one or more tones to generate a symbol duration of four times a legacy duration of 3.2 μseconds (μs).

10. The apparatus of claim 1, wherein one or more tones of the one or more wake-up pulses are to be square root of (1/(2/6)) times [1+1i, 1+1i, −1−1i, 0, −1−1i, 1+1i, 1+1i].

11. The apparatus of claim 1, wherein the processing circuitry is configured to:
use a 64 inverse Fast Fourier Transform (IFFT) on the 26 data ones or the 52 data tones to generate a 3.2μ second time domain sequence.

12. The apparatus of claim 1, wherein one or more tones of the one or more wake-up pulses are to be square root of (1/6) time [1, 1, −1, 0, −1, 1, 1] with a symbol duration of a legacy duration of 3.2 μseconds (μs).

13. The apparatus of claim 1, wherein the wake-up packet indicates that one or more stations are to exit a power save mode.

14. The apparatus of any of claim 1, wherein the one or more wake-up packets each encode one or more wake-up identifiers and wherein the one or more wake-up identifiers are each one from the following group: an identifier generated when the station associates with the wireless local-area network device, a group identifier identifying a group of stations, a unique signage generated when the station associates with the wireless local-area network device, and a unique signage generated based on association parameters when the station associates with the wireless local-area network device.

15. The apparatus of claim 1, wherein the access point is one from the following group: an Institute of Electrical and Electronic Engineers (IEEE) 802.11ax access point, a sensor hub, an IEEE 802.11ax sensor hub, an IEEE 802.11ax station, and an access gateway.

16. The apparatus of claim 1, further comprising one or more antennas coupled to the processing circuitry.

17. A non-transitory computer-readable storage medium that stores instructions for execution by one or more processors, the instructions to configure the one or more processors to cause a wireless device to:
encode one or more wake-up packets to be transmitted on one or more sub-channels to one or more low-power wake-up receivers (LP-WURs), wherein each of the one or more wake-up packets are to be 26 data tones or 52 data tones, and wherein the one or more wake-up packets comprises one or more wake-up pulses; and
cause to be transmitted the one or more wake-up packets in accordance with orthogonal frequency division multiple access (OFDMA) on the one or more sub-channels.

18. The non-transitory computer-readable storage medium of claim 17, wherein the bandwidth of the one or more sub-channels is one from the following group: 2.03125 MHz for 26 data tones, 4.0623 MHz for 52 data tones, a bandwidth that comprises exactly 26 data tones, a second bandwidth that comprises exactly 52 data tones, approximately 2.03125 MHz for 26 data tones, approximately 4.0623 MHz for 52 data tones, and 26 data tones that straddle a DC subcarrier at the center of the sub-channel with null tones at and around the DC.

19. A method performed by a wireless device, the method comprising:
encoding one or more wake-up packets to be transmitted on one or more sub-channels to one or more low-power wake-up receivers (LP-WURs), wherein each of the one or more wake-up packets are to be 26 data tones or 52 data tones, and wherein the wake-up packet comprises one or more wake-up pulses; and
causing to be transmitted the one or more wake-up packets in accordance with orthogonal frequency division multiple access (OFDMA) on the one or more sub-channels.

20. The method of claim 19, wherein the bandwidth of the one or more sub-channels is one from the following group: 2.03125 MHz for 26 data tones, 4.0623 MHz for 52 data tones, a bandwidth that comprises exactly 26 data tones, a second bandwidth that comprises exactly 52 data tones, approximately 2.03125 MHz for 26 data tones, approximately 4.0623 MHz for 52 data tones, and 26 data tones that straddle a DC subcarrier at the center of the sub-channel with null tones at and around the DC.

21. An apparatus of a low-power wake-up receiver (LP-WUR), the apparatus comprising a memory, and processing circuitry coupled to the memory, the processing circuitry configured to:
decode a wake-up packet on a sub-channel, wherein the wake-up packet comprises one or more wake-up pulses, wherein each of the one or more wake-up pulses is to be 26 data tones or 52 data tones, and wherein the wake-up packet is to be received in accordance with ON/OFF keying modulation; and
if the wake-up packet encodes an identifier of the LP-WUR, then the LP-WUR is to generate an exit a power save mode signal.

22. The apparatus of claim 21, wherein the bandwidth of the one or more sub-channels is one from the following group: 2.03125 MHz for 26 data tones, 4.0623 MHz for 52 data tones, a bandwidth that comprises exactly 26 data tones, a second bandwidth that comprises exactly 52 data tones, approximately 2.03125 MHz for 26 data tones, approximately 4.0623 MHz for 52 data tones, and 26 data tones that straddle a DC subcarrier at the center of the sub-channel with null tones at and around the DC.

23. The apparatus of claim 21, wherein the wake-up packet comprises a number of wake-up pulses comprising one or more patterns, wherein each pattern is either an on pattern or an off pattern, and wherein each pattern has a duration of 3.2 μseconds (μs).

24. The apparatus of claim 21, wherein the exit a power save mode signal is to cause a wireless device to exit the power save mode, and wherein the wireless device is one from the following group: an Institute of Electrical and Electronic Engineers (IEEE) 802.11ax access point, a sensor hub, an IEEE 802.11ax sensor hub, an IEEE 802.11ax station, and a Bluetooth® device.

25. The apparatus of claim 21, further comprising one or more antennas coupled to the processing circuitry.
